(19) United States
(12) Patent Application Publication
(10) Pub. No.: US 2008/0181988 A1
(43) Pub. Date: Jul. 31, 2008

(54) Healthy gulp

(76) Inventor: Susan B. Bucenell, Wesley Chapel, FL (US)

Correspondence Address: Susan B. Bucenell, #308, 1936 Bruce B. Downs Blvd., Wesley Chapel, FL, 33543, US

(21) Appl. No.: 12/007,274

(22) Filed: Jan. 9, 2008

Related U.S. Application Data
(60) Provisional application No. 60/879,339, filed on Jan. 9, 2007.

(51) Int. Cl. A23L 2/52; A23L 2/54

(52) U.S. Cl. 426/67; 426/66

(57) ABSTRACT

Healthy Gulp is applying for a patent to protect the uniqueness of its formula. Healthy Gulp is the only bottled water on the market for human or animal consumption that contains fiber. Healthy Gulp is the only bottled water on the market for human or animal consumption that contains stabilized chlorine dioxide.

This application claims priority of provisional application, #60/879339, Filing Date Jan. 9, 2007.

### DETAILED DESCRIPTION (SPECIFICATION)

Substitute Specification-no markings Contains no new matter, only different wording.

Healthy Gulp is a vitamin and mineral flavor enhanced bottled water for cats and dogs with several unique ingredients, including fiber and stabilized chlorine dioxide (SCD). Fiber is included for it's many health benefits. SCD is included as it kills odor causing bacteria in the mouth, thus freshening breath and decreasing the occurrence of tooth decay. It comes in three flavors: plain for both cats and dogs, peanut butter for dogs, and tuna for cats.

1. The only bottled water to contain fiber.

2. The only bottled water to contain Stabilized Chlorine Dioxide.
